(19) United States
(12) Patent Application Publication
(10) Pub. No.: US 2025/0202635 A1
(43) Pub. Date: Jun. 19, 2025

(54) DOWNLINK (DL) PRE-COMPENSATION AND QUASI-CO-LOCATION (QCL) SIGNALING FOR COHERENT JOINT TRANSMISSION (CJT)

(71) Applicant: Telefonaktiebolaget LM Ericsson (publ), Stockholm (SE)

(72) Inventors: Shiwei GAO, Nepean (CA); Siva MURUGANATHAN, Stittsville (CA); Xinlin Zhang, Västra Frölunda (SE)

(21) Appl. No.: 18/845,657

(22) PCT Filed: Mar. 10, 2023
(86) PCT No.: PCT/IB2023/052312

§ 371 Date: Sep. 10, 2024

Related U.S. Application Data
(60) Provisional application No. 63/319,129, filed on Mar. 11, 2022.

(51) Int. Cl. H04L 5/00; H04W 56/00

(52) U.S. Cl. CPC H04L 5/0035; H04L 5/005; H04W 56/0045

(57) ABSTRACT

A method, network node and wireless device (WD) for downlink (DL) pre-compensation and quasi-collocated (QCL) signaling for coherent joint transmission are disclosed. According to one aspect, a method in a network node includes transmitting (S144) a first reference signal (RS) over a first transmission-reception point (TRP) and a second RS over a second TRP. The method includes receiving (S146) time delay difference and/or a frequency difference information between the TRPs. The method includes transmitting (S148) the DL channel with a delay pre-compensation and/or a frequency pre-compensation over the first TRP and without delay or frequency pre-compensation over the second TRP. The method includes transmitting (S150) QCL information indicating whether a DL channel transmitted from the first and second TRPs is pre-compensated. The method further includes pre-compensating (S152) the DL transmission over the first TRP according to the received time delay difference or frequency difference.

### FIELD

The present disclosure relates to wireless communications, and in particular, to downlink (DL) pre-compensation and quasi-collocated (QCL) signaling for coherent joint transmission.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

The next generation mobile wireless communication system (5G) or new radio (NR), will support a diverse set of use cases and a diverse set of deployment scenarios. The later includes deployment at both low frequencies (100s of MHz), similar to LTE today, and very high frequencies (mm waves in the tens of GHz).

Similar to LTE, NR will use OFDM (Orthogonal Frequency Division Multiplexing) in the downlink (i.e., from a network node, gNB, eNB, or base station, to a wireless device (WD)). In the uplink (i.e., from WD to gNB), both OFDM and discrete Fourier transform (DFT)-spread OFDM (DFT-S-OFDM), also known as single carrier frequency division multiple access (SC-FDMA) in LTE, will be supported. The basic NR physical resource may thus be seen as a time-frequency grid as illustrated in the example of FIG. 1 where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{μ}) kHz where μ is a non-negative integer and may be one of {0,1,2,3,4}. Δf=15 kHz (e.g., μ=0) is the basic (or reference) subcarrier spacing that is also used in LTE. μ is also referred to as the numerology.

In the time domain, downlink (DL) and uplink (UL) transmissions in NR are organized into equally-sized subframes of 1 ms each, similar to LTE. A subframe is further divided into multiple slots of equal duration. The slot length is dependent on the subcarrier spacing or numerology and is given by ½^{μ} ms. Each slot includes 14 OFDM symbols for normal Cyclic Prefix (CP).

Data scheduling in NR may be on a slot basis. An example is shown in FIG. 2 with a 14-symbol slot, where the first two symbols contain control channel, such as the physical downlink control channel (PDCCH), and the rest contains data channel, such as the physical downlink shared channel (PDSCH). For convenience, a subframe is referred throughout the following sections.

Downlink transmissions may be dynamically scheduled, i.e., in each slot the network node (gNB) transmits downlink control information (DCI) about which the WD data is to be transmitted to and which resource blocks in the current downlink slot the on which data is transmitted. This control signaling is typically transmitted in the first one or two OFDM symbols in each slot in NR. The control information is carried on a Physical Control Channel (PDCCH) and data is carried on a Physical Downlink Shared Channel (PDSCH). A WD first detects and decodes the PDCCH and if a PDCCH is decoded successfully, it then decodes the corresponding PDSCH based on the decoded control information in the PDCCH.

Uplink data transmission may also be dynamically scheduled using PDCCH. Similar to downlink, a WD first decodes uplink grants in a PDCCH and then transmits data over the Physical Uplink Shared Channel (PUSCH) based on the decoded control information in the uplink grant such as modulation order, coding rate, uplink resource allocation, and etc.

### Tracking Reference Signal (TRS)

Similar to LTE, the Channel State Information Reference Signal (CSI-RS) was introduced in NR for channel measurement in the downlink. A CSI-RS is transmitted over an antenna port (either a physical or virtual antenna) on certain resource elements (REs) for a WD to measure the downlink channel associated with the antenna port. CSI-RS for this purpose is also referred to as Non-Zero Power (NZP) CSI-RS. The supported number of antenna ports or CSI-RS ports in NR are {1, 2, 4, 8, 12, 16, 24, 32}.

A Tracking Reference Signal (TRS) is a special NZP CSI-RS with one port and is used for time and frequency tracking in the downlink. FIG. 3 shows an example of a TRS resource configuration in a physical resource block (PRB) and 2 slots. A WD may be configured with one or more periodic TRS, or one or more periodic TRS and aperiodic TRS in NR. For a periodic TRS, it has a periodicity and a slot offset. The periodicity may be one of 2^{μ}Xₚ slots where Xₚ=10, 20, 40, or 80. A TRS occupies multiple RBs. When a NZP CSI-RS resource set contains “trs-info”, then the NZP CSI-RS resource set is for TRS.

### Quasi Co-Location

Demodulation reference signals (DMRS) are used for coherent demodulation of the PDSCH. A PDSCH may be associated with one or multiple DMRS antenna ports or simply, DMRS ports, each associated with a spatial layer or a multi-input-multiple-output (MIMO) layer. Multiple layers may be multiplexed in a same time and frequency resource, where different data are carried in different layers. The DMRS ports used for a PDSCH transmission are indicated in DCI scheduling the PDSCH.

Several signals may be transmitted from different antenna ports. These signals may have the same large-scale properties, for instance in terms of Doppler shift/spread, average delay spread, or average delay, when measured at a WD receiver. These antenna ports are then said to be quasi co-located (QCL). If the WD knows that two antenna ports, a first and second antenna ports, are QCL with respect to a certain channel property (e.g., Doppler spread), the WD may obtain the channel property of the first antenna port (e.g., DMRS) from the second antenna port (e.g., TRS). The reference signal (e.g., TRS) associated with the second antenna port is known as the QCL source RS and the reference signal (e.g., DMRS) associated with the first antenna port is known as the QCL target RS. The supported QCL types in NR are:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

QCL relations are specified by transmission configuration indicator (TCI) states. A TCI state contains one or two source RS and the associated QCL types. In case two QCL types are configured, one is QCL typed. A WD may be configured by radio resource control (RRC) signaling with a list of TCI states. For PDSCH, one or two TCI states from the list may be activated for each of up to 8 TCI codepoints by a medium access control (MAC) control element (CE) command. Up to 8 TCI states may be activated. One of the TCI codepoints is indicated in DCI scheduling a PDSCH. WD performs PDSCH reception according to the TCI state(s) indicated in the TCI codepoint.

Table 1 is a summary of possible source RS and target RS in NR. SSB refers synchronization signal and broadcast channel block, CSI-RS (BM) refers to CSI-RS for beam management in frequency range 2 (FR2).

TABLE 1
Target and source RS supported in NR.

QCL source RS

| | | | | |
|---|---|---|---|---|
| Target | QCL | QCL | QCL | QCL |
| RS | type A | type B | type C | type D |

| | | | |
|---|---|---|---|
| CSI- | TRS | | TRS |
| RS (CSI) | TRS | | SSB |
| | TRS | | CSI-RS |
| | | | (BM) |
| | | TRS | |
| DMRS | TRS | | TRS |
| for PDSCH | TRS | | CSI-RS |
| | | | (BM) |
| | CSI-RS | | CSI-RS |
| | for CQI | | for CSI |

### CSI Framework in NR

In NR, a WD may be configured with one or multiple Channel State Information (CSI) report configurations for DL CSI feedback by the WD. A CSI report may contain one or more of:
Channel rank indicator (RI);
Antenna precoding matrix indicator (PMI);
Channel quality indicator (CQI);
DL reference signal received power (RSRP) or signal to interference and noise ratio (SINR); and
CSI reference signal (CSI-RS) resource indicator (CRI).

Each CSI report configuration is associated with a bandwidth part (BWP) and contains all the necessary information required for a CSI report, including:
a CSI resource configuration for channel measurement;
reporting type, i.e., aperiodic CSI (on PUSCH), periodic CSI (on PUCCH) or semi-persistent CSI (on PUCCH, and DCI activated on PUSCH); and
report quantity specifying what to be reported, such as RI, PMI, CQI, RSRP, etc.

A WD may be configured with one or multiple CSI resource configurations for channel measurement. Each CSI resource configuration for channel measurement may contain one or more NZP CSI-RS resource sets. For each NZP CSI-RS resource set, it may further contain one or more NZP CSI-RS resources. A NZP CSI-RS resource may be periodic, semi-persistent, or aperiodic.

Periodic CSI starts after it has been configured by radio resource control (RRC) and is reported on PUCCH, the associated NZP CSI-RS resource(s) are also periodic.

For aperiodic CSI, reporting is on PUSCH and is activated by a CSI request bit field in DCI. The associated NZP CSI-RS resource(s) may be either periodic, semi-persistent, or aperiodic. The linkage between a code point of the CSI request field and a CSI report configuration is via an aperiodic CSI trigger state. A WD is configured by higher layer a list of aperiodic CSI trigger states, where each of the trigger states contains an associated CSI report configuration. The CSI request field is used to indicate one of the aperiodic CSI trigger states and thus, one CSI report configuration.

If there is more than one NZP CSI-RS resource set and/or more than one CSI-IM resource set that is associated with a CSI report configuration, only one NZP CSI-RS resource set is selected in the aperiodic CSI trigger state. Thus, each aperiodic CSI report is based on a single NZP CSI-RS resource set.

CQI and PMI may be reported per subband or wideband. In case of wideband CQI or PMI, the CQI or PMI is for the whole bandwidth configured for CSI report. In case of subband QCI or PMI, the CQI or PMI is reported for each subband. The subband size in NR may be from 4 RBs to 32 RBs, depending on the size of the BWP as shown in the table below.

TABLE 5.2.1.4-2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

PDSCH Transmission from Multiple TRPs

In NR 3GPP Technical Release 16 (3GPP Rel-16), non-coherent joint (NC-JT) PDSCH transmission from two transmission and reception points (TRPs) was introduced in which a subset of MIMO layers of a PDCCH to a WD are transmitted from a first TRP and the rest of layers of the PDSCH are transmitted from a second TRP in the same time and frequency resource. Different layers are separated and received at the WD by a MIMO capable receiver.

An example is shown in FIG. 4, where a PDSCH with two layers are scheduled with the first layer transmitted from TRP1 and the second layer from TRP2. This is signaled in the corresponding DCI by indicating a TCI codepoint associated with two TCI states, a first and second TCI states, and DMRS ports x and y in two CDM groups, where DMRS port x in the first CDM group is associated with the first TCI state and DMRS port y in the second CDM group is associated with the second TCI state. The first TCI state may include tracking reference signal 1 (TRS1) as the QCL source RS and the second TCI state may include TRS1 as the QCL source RS.

### SFN PDSCH

In NR 3GPP Rel-17, enhanced single frequency network (SFN) based PDSCH was also introduced for more robust PDSCH reception in which a PDSCH is transmitted simultaneously from two TRPs in a same time and frequency resource.

An example is shown in FIG. 5, where an exact same PDSCH together with its DMRS is transmitted from both TRPs. This is indicated to a WD by both a RRC configuration of system frame number (SFN) PDSCH and two TCI states indicated in a DCI scheduling the PDSCH. The first TCI state may contain TRS1 as the QCL source RS and the second TCI state may contain TRS2 as the QCL source RS. The DMRS is now associated with the two TCI states because the DMRS is transmitted from both TRPs.

In NC-JT based multi-TRP PDSCH, different layers or data are transmitted from different TRPs, so for each layer it is only transmitted from one TRP. For SFN based multi-TRP PDSCH, the same data are transmitted from different TRPs. The corresponding signals from different TRPs may be combined either constructively or destructively depending on the relative phase between the signals when they reach the WD. To mitigate the issue of possible signal cancellation, cyclic delay diversity (CDD) is typically used in implementation to introduce a frequency dependent phase shift between the signals such that the relative phase between the signals vary over the scheduled bandwidth.

To further enhance multi-TRP PDSCH transmission, coherent joint transmission (CJT) of a PDSCH from multiple TRPs will be studied and supported in NR 3GPP Rel-18, in which signals from multiple TRPs are coherently combined at a WD through proper joint antenna precoding at the multiple TRPs. This is to be achieved by CSI feedback in which the WD measures the channels associated with the multiple TRPs and reports back a joint precoder across the multiple TRPs such that the precoded signals from the multiple TRPs are phase aligned when they reach the WD.

However, there are a number of challenges in supporting CJT. First, propagation delays between different TRPs and a WD may be quite different. These large delay differences would result in a large frequency selective composite channel, i.e., the channel amplitude and phase vary rapidly across frequency. In existing NR CSI feedback, a precoding matrix per subband is reported. The subband size may vary between 2 RBs to 32 RBs as specified in 3GPP Technical Standard (TS) 38.214. FIG. 6 shows phase variation within a subband for different subband sizes with one microsecond (1 us) delay difference between two TRPs. Even with a two resource block (RB) subband size, the phase variation exceeds 130 degrees. For constructive combining of two signals, their phase difference should be less than 90 degrees. Therefore, with current subband size and per subband CSI feedback, signals from multiple TRPs cannot be coherently combined with even 1 us delay difference.

Second, even though a same nominal transmit frequency may be used at multiple TRPs, due to local oscillator stability, there will be some actual transmit frequency difference between the multiple TRPs. In 3GPP RAN4, the maximum transmit frequency error for a base station is specified in 3GPP Technical Standard (TS) 38.104 and is shown in FIG. 7. For the most stringent +/−0.05 ppm requirement, there will be some residual frequency errors. These frequency errors means that the phase of a signal will change over time. Table 2 shows phase variation over 5 ms time period with +/−0.05 ppm at different nominal transmit frequencies. It may be seen that even at 1 GHz carrier frequency, the phase may change up to 180 degrees over 5 ms time period. In other words, the time offset between the time at which a CSI is measured at the WD and the time at which a CSI is applied needs to much less than 5 ms. This is not practical in most cases.

TABLE 2
phase change due frequency errors (+/−0.05 ppm)

| | Max | | Max |
|---|---|---|---|
| Carrier | frequency | Time | phase |
| frequency | difference | duration | change |
| (GHz) | (Hz) | (ms) | (deg) |
| 1 | 100 | 5 | 180 |
| 2 | 200 | 5 | 360 |
| 4 | 400 | 5 | 720 |
| 6 | 600 | 5 | 1080 |

### SUMMARY

Some embodiments advantageously provide methods, network nodes and wireless devices for downlink (DL) pre-compensation and quasi-collocated (QCL) signaling for coherent joint transmission.

Allowing CSI feedback for CJT with the existing subband sizes and enable CJT of PDSCH with practical CSI feedback latency.

According to one aspect, a network node configured to communicate with a wireless device, WD, is provided. The network node is configured for coherent joint transmission, CJT, of a downlink, DL, channel to the WD over a first transmission and reception point, TRP, and a second TRP in a same time and frequency resource. The network node includes a radio interface configured to: transmit to the WD, a first reference signal, RS, over the first TRP and a second RS over the second TRP; receive from the WD, information relating to at least one of a time delay difference and a frequency difference between the first and the second TRPs at the WD, wherein the second TRP is a reference TRP; transmit to the WD, the DL channel with at least one of a delay pre-compensation and a frequency pre-compensation over the first TRP and without delay and frequency pre-compensation over the second TRP; and transmit to the WD, quasi co-location, QCL, information indicating whether the DL channel transmitted from each of the first and second TRPs is pre-compensated. The network node also includes processing circuitry in communication with the radio interface and configured to pre-compensate the downlink channel transmitted to the WD over the first TRP according to the received at least one of the time delay difference and frequency difference.

According to this aspect, in some embodiments, the DL channel is a Physical Downlink Shared Channel, PDSCH. In some embodiments, the QCL information is included in a DL control information, DCI, format scheduling the DL channel. In some embodiments, the QCL information for the DL channel transmitted from the first TRP is included in a first transmission configuration indication, TCI, state and the QCL information for the DL channel transmitted from the second TRP is included in a second transmission configuration indication, TCI, state, the first and second TCI states being indicated in a TCI codepoint of a TCI field in downlink control information, DCI. In some embodiments, the QCL information in the first TCI state includes both an average delay and Doppler shift properties, while the QCL information in the second TCI state does not include either of the average delay and the Doppler shift properties. In some embodiments, the first and the second TCI states are indicated one of implicitly and explicitly. In some embodiments, only the first TCI state is indicated in the TCI codepoint in the DCI. In some embodiments, the delay pre-compensation is performed by applying one of a time advance and a time delay to the DL channel. In some embodiments, the frequency pre-compensation is performed by applying a frequency correction to the DL channel. In some embodiments, the QCL information further indicates one of delay pre-compensation, frequency pre-compensation, both delay and frequency pre-compensation, and no pre-compensation. In some embodiments, the at least one of the delay pre-compensation and the frequency pre-compensation is performed by applying a phase rotation in each subcarrier of the DL channel or signal In some embodiments, the radio interface is further configured to receive channel state information, CSI, feedback from the WD, the CSI feedback including a precoding matrix indicator, PMI, indicating a first precoding matrix for the DL channel from the first TRP and indicating a second precoding matrix for the DL channel from the second TRP. In some embodiments, the first RS and the second RS are channel state information reference signals, CSI-RS. In some embodiments, the first RS and the second RS are tracking reference signals, TRS. In some embodiments, the time delay difference and the frequency difference are reported with channel state information, CSI. In some embodiments, at least one of the time delay difference and the frequency difference are obtained by the network node based on uplink measurements on uplink reference signals.

According to another aspect, a method in a network node configured to communicate with a wireless device, WD, is provided, the network node being configured for coherent joint transmission, CJT, of a downlink, DL, channel to the WD over a first transmission and reception point, TRP, and a second TRP in a same time and frequency resource. The method includes: transmitting to the WD, a first reference signal, RS, over the first TRP and a second RS over the second TRP; receiving from the WD, information relating to at least one of a time delay difference and a frequency difference between the first and the second TRPs at the WD, wherein the second TRP is a reference TRP; transmitting to the WD, the DL channel with at least one of a delay pre-compensation and a frequency pre-compensation over the first TRP and without delay and frequency pre-compensation over the second TRP; transmitting to the WD, quasi co-location, QCL, information indicating whether the DL channel transmitted from each of the first and second TRPs is pre-compensated; and pre-compensating the downlink channel transmitted to the WD over the first TRP according to the received at least one of the time delay difference and frequency difference.

According to this aspect, in some embodiments, the DL channel is a Physical Downlink Shared Channel, PDSCH. In some embodiments, the QCL information is included in a DL control information, DCI, format scheduling the DL channel. In some embodiments, the QCL information for the DL channel transmitted from the first TRP is included in a first transmission configuration indication, TCI, state and the QCL information for the DL channel transmitted from the second TRP is included in a second transmission configuration indication, TCI, state, the first and second TCI states being indicated in a TCI codepoint of a TCI field in downlink control information, DCI. In some embodiments, the QCL information in the first TCI state includes both an average delay and Doppler shift properties, while the QCL information in the second TCI state does not include either of the average delay and the Doppler shift properties. In some embodiments, the first and the second TCI states are indicated one of implicitly and explicitly. In some embodiments, only the first TCI state is indicated in the TCI codepoint in the DCI. In some embodiments, the delay pre-compensation is performed by applying one of a time advance and a time delay to the DL channel. In some embodiments, the frequency pre-compensation is performed by applying a frequency correction to the DL channel. In some embodiments, the QCL information further indicates one of delay pre-compensation, frequency pre-compensation, both delay and frequency pre-compensation, and no pre-compensation. In some embodiments, the at least one of the delay pre-compensation and the frequency pre-compensation is performed by applying a phase rotation in each subcarrier of the DL channel or signal. In some embodiments, the method includes receiving channel state information, CSI, feedback from the WD, the CSI feedback including a precoding matrix indicator, PMI, indicating a first precoding matrix for the DL channel from the first TRP and indicating a second precoding matrix for the DL channel from the second TRP. In some embodiments, the first RS and the second RS are channel state information reference signals, CSI-RS. In some embodiments, the first RS and the second RS are tracking reference signals, TRS. In some embodiments, the time delay difference and the frequency difference are reported with channel state information, CSI. In some embodiments, at least one of the time delay difference and the frequency difference are obtained by the network node based on uplink measurements on uplink reference signals.

According to yet another aspect, a WD configured to communicate with a plurality of transmission reception points, TRPs, is provided. The WD includes a radio interface configured to receive from the network node a configuration to report at least one of a delay difference and a frequency difference between the first and the second TRPs based on a first reference signal, RS, and a second RS, the first RS and the second RS being transmitted from the first TRP and the second TRP, respectively. The WD includes processing circuitry in communication with the radio interface and configured to estimate at least one of the delay difference and the frequency difference based on the first and the second RS. The radio interface is further configured to: report to the network node the estimated at least one of the delay difference and the frequency difference; receive from the network node a downlink channel scheduled by a downlink control information, DCI, format and quasi co-location, QCL, information about the downlink channel in the DCI, the downlink channel being transmitted over both the first and the second TRPs; and decode the downlink channel according to the QCL information.

According to this aspect, in some embodiments, the delay difference includes at least one of a timing difference and a propagation delay difference between the first and the second TRPs. In some embodiments, the frequency difference includes at least one of a downlink carrier frequency difference and a downlink Doppler frequency difference between the first and the second TRPs. In some embodiments, the downlink channel is a physical downlink shared channel, PDSCH. In some embodiments, the QCL information for the DL channel transmitted from the first is included in a first transmission configuration indication, TCI, state and the QCL information for the downlink channel transmitted from the second TRP is included in a second TCI, state, at least one of the first and second TCI states being indicated in a TCI codepoint of a TCI field in the DCI. In some embodiments, the QCL information in the first TCI state includes Doppler shift, Doppler spread, average delay and delay spread. In some embodiments, the QCL information in the second TCI state excludes at least one of Doppler shift and average delay. In some embodiments, only the first TCI state is indicated in the TCI field of the DCI and QCL information included in the first TCI state is applied to a physical downlink shared channel, PDSCH. In some embodiments, the QCL information further indicates a QCL source reference signal. In some embodiments, decoding the DL channel according to the QCL information includes deriving channel properties indicated in the QCL information from an associated QCL source RS for the physical downlink shared channel, PDSCH, and using the channel properties to perform channel estimation for the PDSCH. In some embodiments, each of the first and second RS is a channel state information reference signal, CSI-RS. In some embodiments, each of the first and second RS is a tracking reference signal, TRS.

According to another aspect, a method in a wireless device, WD, configured to communicate with a network node including a first transmission reception point, TRP, and a second TRP, is provided. The method includes: receiving from the network node a configuration to report at least one of a delay difference and a frequency difference between the first and the second TRPs based on a first reference signal, RS, and a second RS, the first RS and the second RS being transmitted from the first TRP and the second TRP, respectively; estimating at least one of the delay difference and the frequency difference based on the first and the second RS; reporting to the network node the estimated at least one of the delay difference and the frequency difference; receiving from the network node a downlink channel scheduled by a downlink control information, DCI, format and quasi co-location, QCL, information about the downlink channel in the DCI, the downlink channel being transmitted over both the first and the second TRPs; and decoding the downlink channel according to the QCL information.

According to this aspect, in some embodiments, the delay difference includes at least one of a timing difference and a propagation delay difference between the first and the second TRPs. In some embodiments, the frequency difference includes at least one of a downlink carrier frequency difference and a downlink Doppler frequency difference between the first and the second TRPs. In some embodiments, the downlink channel is a physical downlink shared channel, PDSCH. In some embodiments, the QCL information for the DL channel transmitted from the first is included in a first transmission configuration indication, TCI, state and the QCL information for the downlink channel transmitted from the second TRP is included in a second TCI, state, at least one of the first and second TCI states being indicated in a TCI codepoint of a TCI field in the DCI. In some embodiments, the QCL information in the first TCI state includes Doppler shift, Doppler spread, average delay and delay spread. In some embodiments, the QCL information in the second TCI state excludes at least one of Doppler shift and average delay. In some embodiments, only the first TCI state is indicated in the TCI field of the DCI and QCL information included in the first TCI state is applied to a physical downlink shared channel, PDSCH. In some embodiments, the QCL information further indicates a QCL source reference signal. In some embodiments, decoding the DL channel according to the QCL information includes deriving channel properties indicated in the QCL information from an associated QCL source RS for the physical downlink shared channel, PDSCH, and using the channel properties to perform channel estimation for the PDSCH. In some embodiments, each of the first and second RS is a channel state information reference signal, CSI-RS. In some embodiments, each of the first and second RS is a tracking reference signal, TRS.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of NR physical resources;

FIG. 2 is a diagram of an NR time-domain structure;

FIG. 3 is an example of resource elements;

FIG. 4 is an example of non-coherent joint transmission;

FIG. 5 is an example of transmission of a PDSCH from two TRPs;

FIG. 6 is a table of phase variations per subband size;

FIG. 7 is a table of transmit frequency accuracies;

FIG. 8 is a schematic diagram of an example network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating example methods implemented in a communication system including a host computer, a network node and a wireless device for executing a client application at a wireless device according to some embodiments of the present disclosure;

FIG. 11 is a flowchart illustrating example methods implemented in a communication system including a host computer, a network node and a wireless device for receiving user data at a wireless device according to some embodiments of the present disclosure;

FIG. 12 is a flowchart illustrating example methods implemented in a communication system including a host computer, a network node and a wireless device for receiving user data from the wireless device at a host computer according to some embodiments of the present disclosure;

FIG. 13 is a flowchart illustrating example methods implemented in a communication system including a host computer, a network node and a wireless device for receiving user data at a host computer according to some embodiments of the present disclosure;

FIG. 14 is a flowchart of an example process in a network node for downlink (DL) pre-compensation and quasi-collocated (QCL) signaling for coherent joint transmission;

FIG. 15 is a flowchart of an example process in a wireless device for downlink (DL) pre-compensation and quasi-collocated (QCL) signaling for coherent joint transmission;

FIG. 16 is a flowchart of an example process in a network node for downlink (DL) pre-compensation and quasi-collocated (QCL) signaling for coherent joint transmission;

FIG. 17 is a flowchart of an example process in a wireless device for downlink (DL) pre-compensation and quasi-collocated (QCL) signaling for coherent joint transmission;

FIG. 18 is an example of coherent joint transmission (CJT) from two TRPs;

FIG. 19 is an example of CSI measurement and feedback for CJT from two TRPs;

FIG. 20 is an example of delay compensation;

FIG. 21 is another example of CSI measurement and feedback for CJT from two TRPs; and

FIG. 22 is an example of implicit indication of delay and/or frequency compensation.

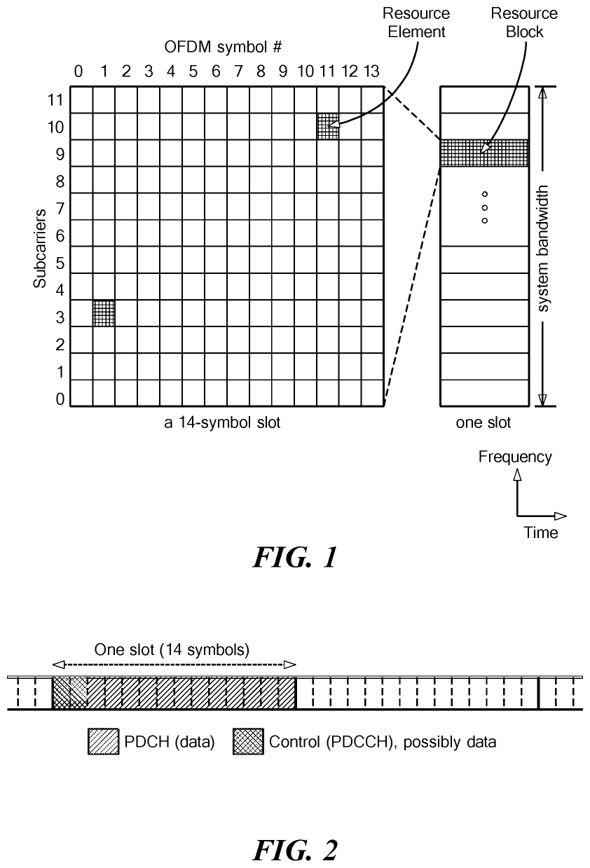

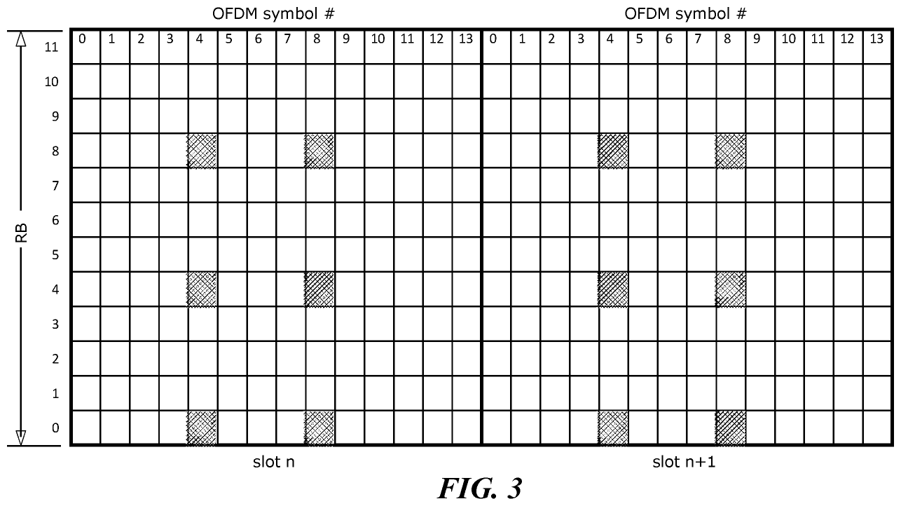

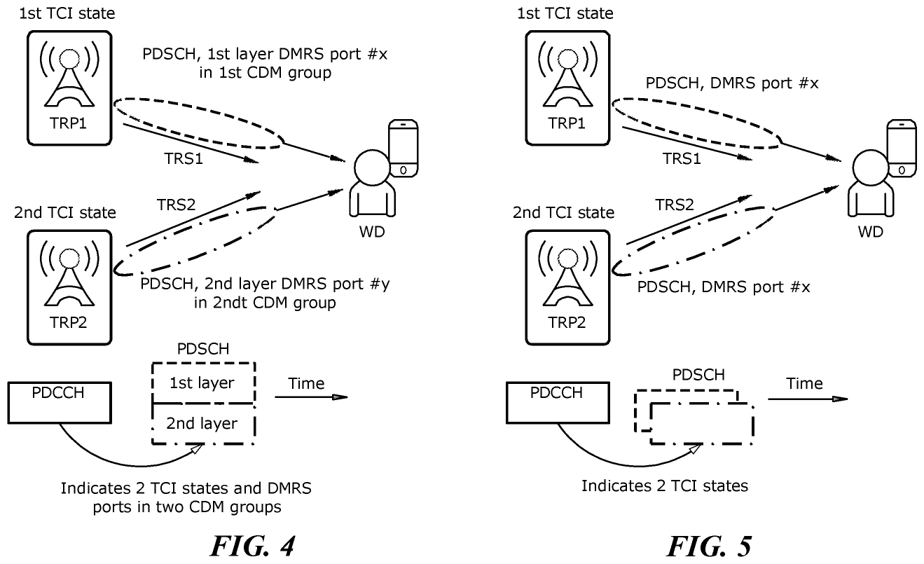

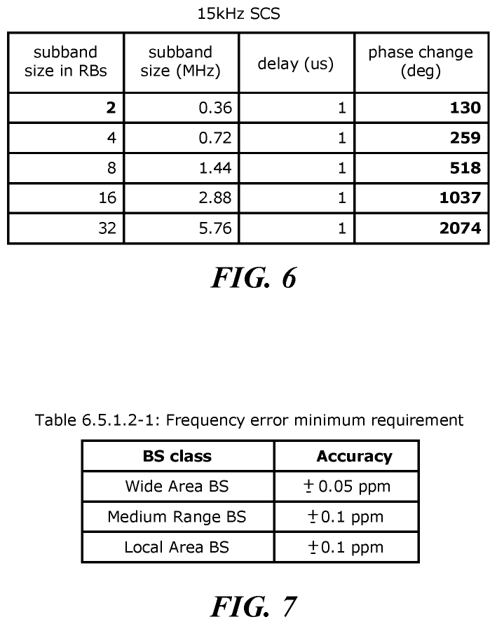

### DETAILED DESCRIPTION

Before describing in detail example embodiments, it is noted that the embodiments reside primarily in combinations of apparatus components and processing steps related to downlink (DL) pre-compensation and quasi-collocated (QCL) signaling for coherent joint transmission. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide downlink (DL) pre-compensation and quasi-collocated (QCL) signaling for coherent joint transmission.

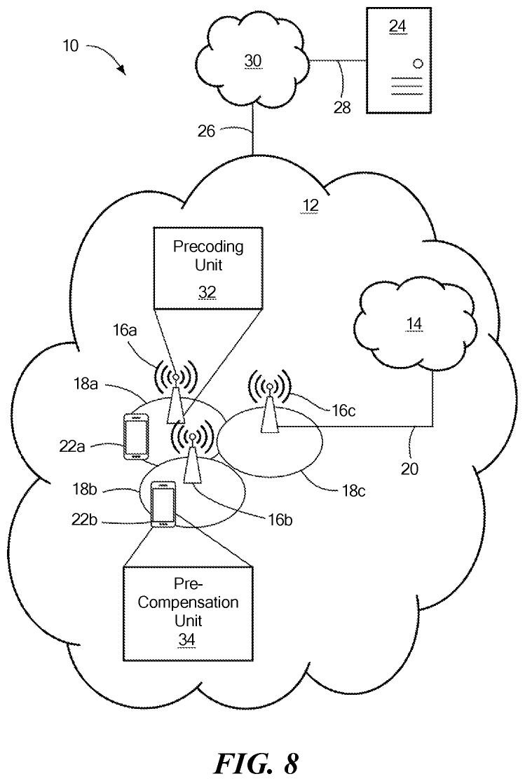

Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a precoding unit 32 which may be configured to apply one of a delay and a frequency pre-compensation to a downlink signal. The precoding unit 32 may be configured to pre-compensate the downlink channel transmitted to the WD (22) over the first TRP according to the received at least one of the time delay difference and frequency difference. A WD 22 is configured to include a pre-compensation unit 34 which may be configured to pre-compensate one of a delay difference and frequency difference among multiple transmission reception points, TRPs, for a physical downlink shared channel, PDSCH. The pre-compensation unit 34 may be configured to estimate at least one of the delay difference and the frequency difference based on the first and the second RS.

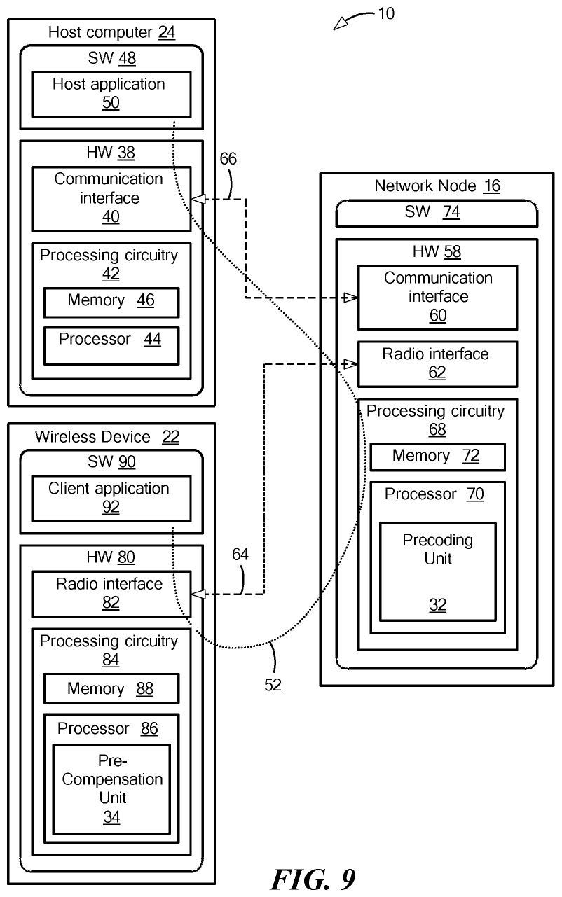

Example implementations, in accordance with an embodiment, of the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include precoding unit 32 configured to apply one of a delay and a frequency pre-compensation to a downlink signal. The precoding unit 32 may be configured to pre-compensate the downlink channel transmitted to the WD (22) over the first TRP according to the received at least one of the time delay difference and frequency difference.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a pre-compensation unit 34 configured to pre-compensate one of a delay difference and frequency difference among multiple transmission reception points, TRPs, for a physical downlink shared channel, PDSCH. The pre-compensation unit 34 may be configured to estimate at least one of the delay difference and the frequency difference based on the first and the second RS.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as precoding unit 32, and pre-compensation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

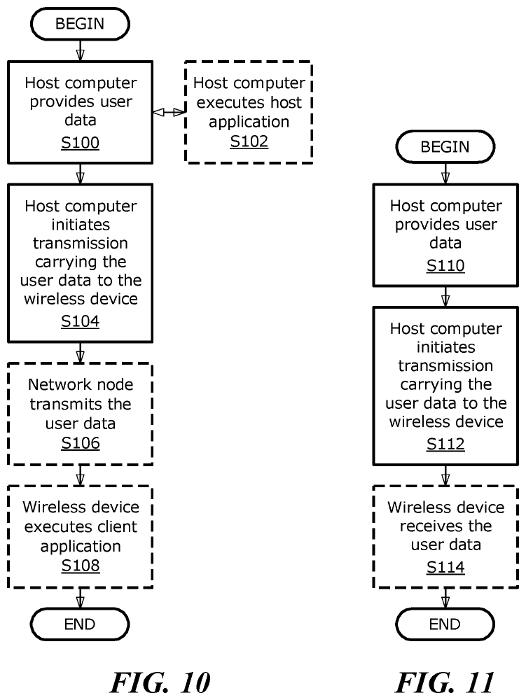

FIG. 10 is a flowchart illustrating an example method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

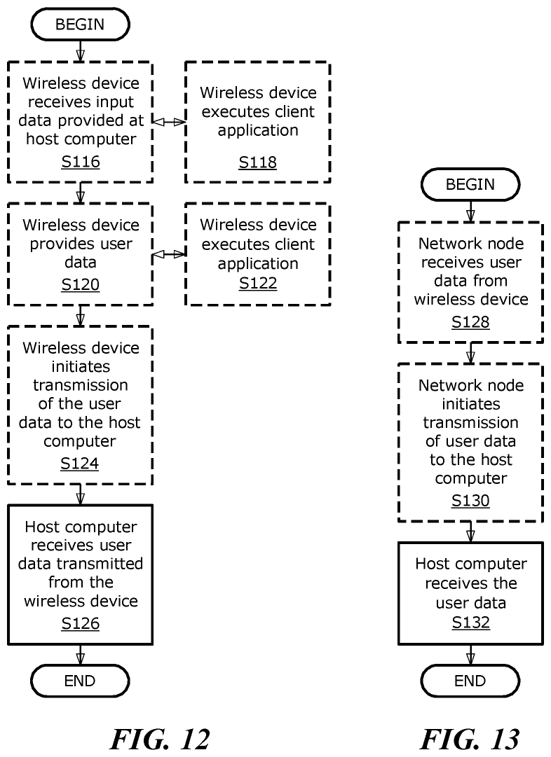

FIG. 12 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

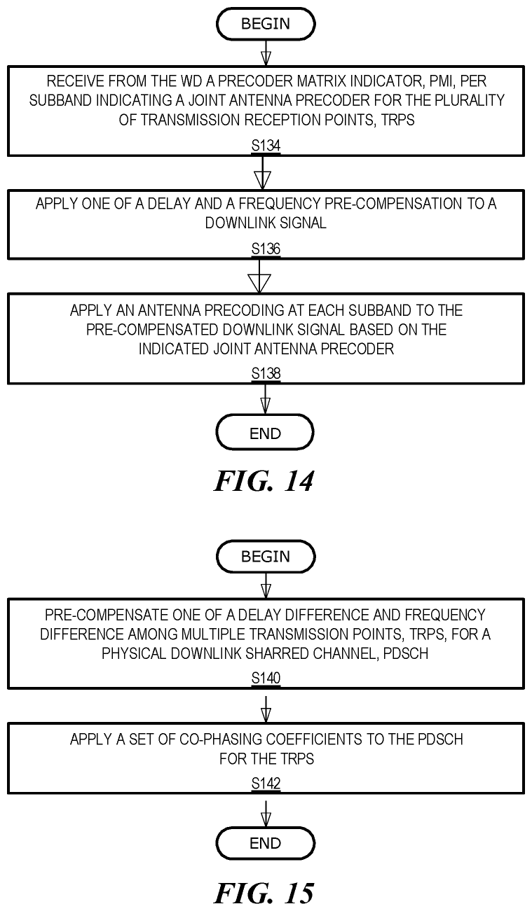

FIG. 14 is a flowchart of an example process in a network node 16 for downlink (DL) pre-compensation and quasi-collocated (QCL) signaling for coherent joint transmission. One or more blocks described herein may be performed by one or more elements of network node 16 such as by one or more of processing circuitry 68 (including the precoding unit 32), processor 70, radio interface 62 and/or communication interface 60. Network node 16 such as via processing circuitry 68 and/or processor 70 and/or radio interface 62 and/or communication interface 60 is configured to receive from the WD a precoder matrix indicator, PMI, per subband indicating a joint antenna precoder for the plurality of transmission reception points, TRPs (Block S134). The process also includes applying one of a delay and a frequency pre-compensation to a downlink signal (Block S136). The process also includes applying an antenna precoding at each subband to the pre-compensated downlink signal based on the indicated joint antenna precoder (Block S138).

In some embodiments, the one of the delay and frequency pre-compensation is based at least in part on a time delay between TRPs. In some embodiments, applying one of a delay and a frequency pre-compensation includes applying the one of the delay and the frequency pre-compensation to the plurality of TRPs. In some embodiments, the method also includes transmitting quasi-co-location, QCL, information to the WD. In some embodiments, the method includes linking a first TRP to a first transmission configuration indicator, TCI, state and associating a set of remaining TCI states with other TRPs.

FIG. 15 is a flowchart of an example process in a wireless device 22 according to some embodiments of the present disclosure. One or more blocks described herein may be performed by one or more elements of wireless device 22 such as by one or more of processing circuitry 84 (including the pre-compensation unit 34), processor 86, radio interface 82 and/or communication interface 60. Wireless device 22 such as via processing circuitry 84 and/or processor 86 and/or radio interface 82 is configured to pre-compensate one of a delay difference and frequency difference among multiple transmission reception points, TRPs, for a physical downlink shared channel, PDSCH (Block S140); and apply a set of co-phasing coefficients to the PDSCH for the TRPs (Block S142).

In some embodiments, the one of the delay difference and frequency difference is determined based at least in part on measurements at the WD 22. In some embodiments, the one of the delay difference and frequency difference is determined based at least in part on measurements at the network node 16. In some embodiments, the one of the delay difference and frequency difference is based at least in part on a reference signal associated with a reference TRP. In some embodiments, the method also includes determining a set of channel properties based at least in part on a quasi-co-location type. In some embodiments, the method also includes transmitting the co-phasing coefficients to the network node 16.

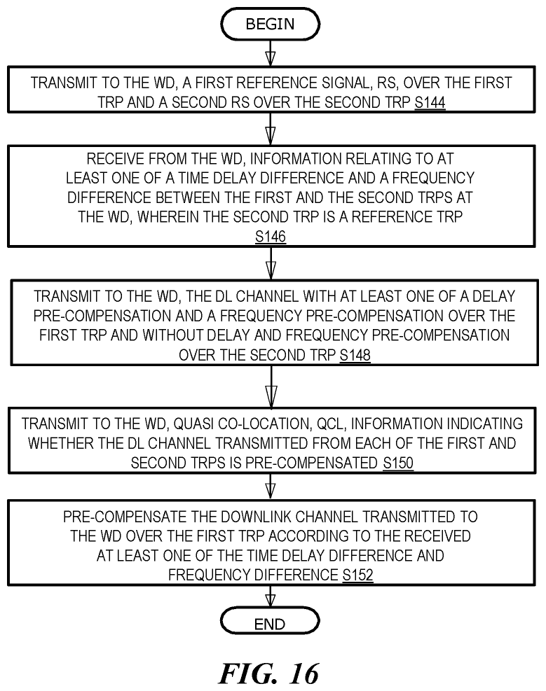

FIG. 16 is a flowchart of another example process in a network node 16 for downlink (DL) pre-compensation and quasi-collocated (QCL) signaling for coherent joint transmission. One or more blocks described herein may be performed by one or more elements of network node 16 such as by one or more of processing circuitry 68 (including the precoding unit 32), processor 70, radio interface 62 and/or communication interface 60. Network node 16 such as via processing circuitry 68 and/or processor 70 and/or radio interface 62 and/or communication interface 60 is configured to transmit to the WD 22, a first reference signal, RS, over the first TRP and a second RS over the second TRP (Block S144); receiving from the WD 22, information relating to at least one of a time delay difference and a frequency difference between the first and the second TRPs at the WD 22, wherein the second TRP is a reference TRP (Block S146); transmitting to the WD 22, the DL channel with at least one of a delay pre-compensation and a frequency pre-compensation over the first TRP and without delay and frequency pre-compensation over the second TRP (Block S148); transmitting to the WD 22, quasi co-location, QCL, information indicating whether the DL channel transmitted from each of the first and second TRPs is pre-compensated (Block S150); and pre-compensating the downlink channel transmitted to the WD 22 over the first TRP according to the received at least one of the time delay difference and frequency difference (Block S152).

In some embodiments, the DL channel is a Physical Downlink Shared Channel, PDSCH. In some embodiments, the QCL information is included in a DL control information, DCI, format scheduling the DL channel. In some embodiments, the QCL information for the DL channel transmitted from the first TRP is included in a first transmission configuration indication, TCI, state and the QCL information for the DL channel transmitted from the second TRP is included in a second transmission configuration indication, TCI, state, the first and second TCI states being indicated in a TCI codepoint of a TCI field in downlink control information, DCI. In some embodiments, the QCL information in the first TCI state includes both an average delay and Doppler shift properties, while the QCL information in the second TCI state does not include either of the average delay and the Doppler shift properties. In some embodiments, the first and the second TCI states are indicated one of implicitly and explicitly. In some embodiments, only the first TCI state is indicated in the TCI codepoint in the DCI. In some embodiments, the delay pre-compensation is performed by applying one of a time advance and a time delay to the DL channel. In some embodiments, the frequency pre-compensation is performed by applying a frequency correction to the DL channel. In some embodiments, the QCL information further indicates one of delay pre-compensation, frequency pre-compensation, both delay and frequency pre-compensation, and no pre-compensation. In some embodiments, the at least one of the delay pre-compensation and the frequency pre-compensation is performed by applying a phase rotation in each subcarrier of the DL channel or signal. In some embodiments, the method includes receiving channel state information, CSI, feedback from the WD 22, the CSI feedback including a precoding matrix indicator, PMI, indicating a first precoding matrix for the DL channel from the first TRP and indicating a second precoding matrix for the DL channel from the second TRP. In some embodiments, the first RS and the second RS are channel state information reference signals, CSI-RS. In some embodiments, the first RS and the second RS are tracking reference signals, TRS. In some embodiments, the time delay difference and the frequency difference are reported with channel state information, CSI. In some embodiments, at least one of the time delay difference and the frequency difference are obtained by the network node 16 based on uplink measurements on uplink reference signals.

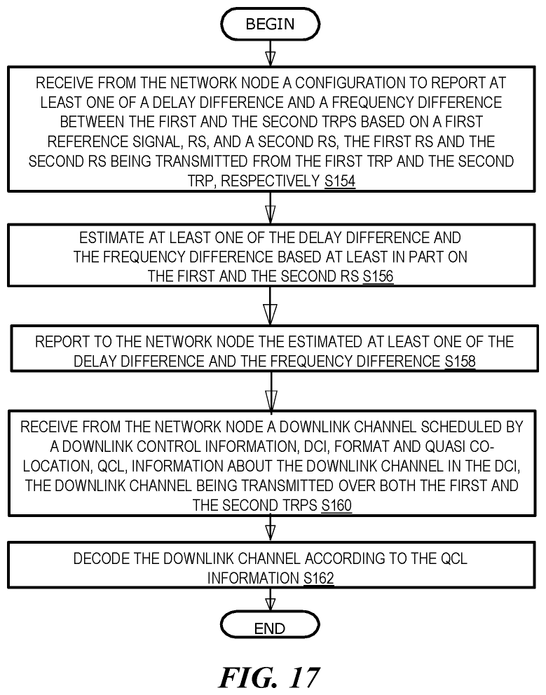

FIG. 17 is a flowchart of another example process in a wireless device 22 according to some embodiments of the present disclosure. One or more blocks described herein may be performed by one or more elements of wireless device 22 such as by one or more of processing circuitry 84 (including the pre-compensation unit 34), processor 86, radio interface 82 and/or communication interface 60. Wireless device 22 such as via processing circuitry 84 and/or processor 86 and/or radio interface 82 is configured to receive from the network node 16 a configuration to report at least one of a delay difference and a frequency difference between the first and the second TRPs based on a first reference signal, RS, and a second RS, the first RS and the second RS being transmitted from the first TRP and the second TRP, respectively (Block S154); estimating at least one of the delay difference and the frequency difference based on the first and the second RS (Block S156); reporting to the network node 16 the estimated at least one of the delay difference and the frequency difference (Block S158); receiving from the network node 16 a downlink channel scheduled by a downlink control information, DCI, format and quasi co-location, QCL, information about the downlink channel in the DCI, the downlink channel being transmitted over both the first and the second TRPs (Block S160); and decoding the downlink channel according to the QCL information (Block S162).

In some embodiments, the delay difference includes at least one of a timing difference and a propagation delay difference between the first and the second TRPs. In some embodiments, the frequency difference includes at least one of a downlink carrier frequency difference and a downlink Doppler frequency difference between the first and the second TRPs. In some embodiments, the downlink channel is a physical downlink shared channel, PDSCH. In some embodiments, the QCL information for the DL channel transmitted from the first is included in a first transmission configuration indication, TCI, state and the QCL information for the downlink channel transmitted from the second TRP is included in a second TCI, state, at least one of the first and second TCI states being indicated in a TCI codepoint of a TCI field in the DCI. In some embodiments, the QCL information in the first TCI state includes Doppler shift, Doppler spread, average delay and delay spread. In some embodiments, the QCL information in the second TCI state excludes at least one of Doppler shift and average delay. In some embodiments, only the first TCI state is indicated in the TCI field of the DCI and QCL information included in the first TCI state is applied to a physical downlink shared channel, PDSCH. In some embodiments, the QCL information further indicates a QCL source reference signal. In some embodiments, decoding the DL channel according to the QCL information includes deriving channel properties indicated in the QCL information from an associated QCL source RS for the physical downlink shared channel, PDSCH, and using the channel properties to perform channel estimation for the PDSCH. In some embodiments, each of the first and second RS is a channel state information reference signal, CSI-RS. In some embodiments, each of the first and second RS is a tracking reference signal, TRS.

Having described the general process flow of arrangements of the disclosure and having provided examples of hardware and software arrangements for implementing the processes and functions of the disclosure, the sections below provide details and examples of arrangements for downlink (DL) pre-compensation and quasi-collocated (QCL) signaling for coherent joint transmission.

### Coherent Joint Transmission

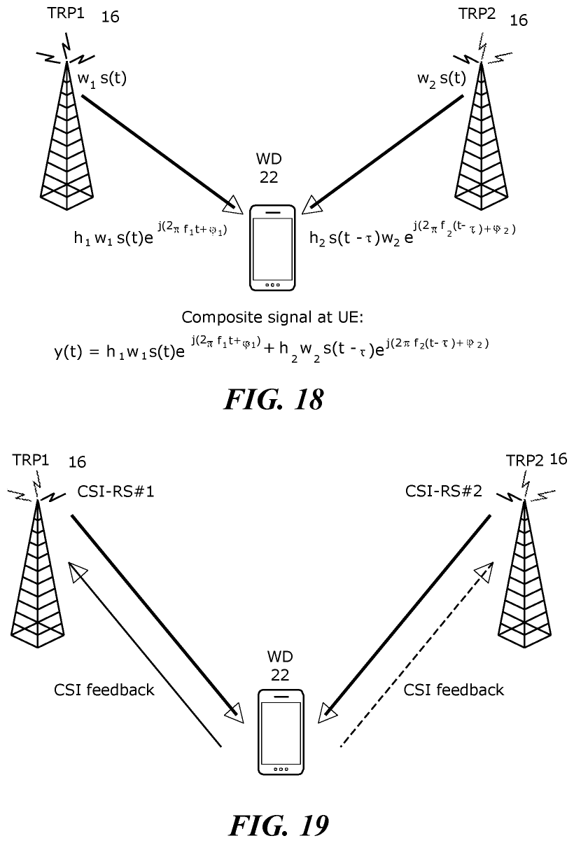

FIG. 18 shows an example of transmission of a signal s(t) from two TRPs. s(t) is multiplied by two co-phasing coefficients w₁ and w₂ at the two TRPs before being transmitted to the WD 22. The effective propagation channels from the two TRPs to the WD 22, including transmitter and receiver circuitries and antenna patterns associated with the two TRPs, are denoted by h₁ and h₂, respectively. f₁ and f₂ are the transmit frequencies and φ₁ and φ₂ are the random initial phases at the two TRPs. τ is the propagation delay (including possible timing offsets) difference between the two TRPs.

The composite signal at the WD 22 may be expressed as

$$y ( t ) = {h}_{1} {w}_{1} s ( t ) {e}^{j ( 2 π {f}_{1} t + {φ}_{1} )} + {h}_{2} {w}_{2} s ( t - τ ) {e}^{j ( 2 π {f}_{2} ( t - τ ) + {φ}_{2} )} \qquad ( eq . 1 )$$

For a narrow-band signal and when the delay t is small, the signal envelope doesn't change much, i.e., s(t−τ)≈s(t). Thus:

$$y ( t ) \approx {h}_{1} {w}_{1} s ( t ) {e}^{j ( 2 π {f}_{1} t + {φ}_{1} )} + {h}_{2} {w}_{2} s ( t ) {e}^{j ( 2 π {f}_{2} ( t - τ ) + {φ}_{2} )} \qquad ( eq . 2 )$$

$$or$$

$$y ( t ) \approx ( {h}_{1} {w}_{1} {e}^{j {φ}_{1}} + {h}_{2} {w}_{2} {e}^{j ( 2 π ( {f}_{2} - {f}_{1} ) t - 2 π {f}_{2} τ + {φ}_{2} )} ) s ( t ) {e}^{j 2 π {f}_{1} t} \qquad ( eq . 3 )$$

To coherently combine the signals from the two TRPs, the following co-phasing coefficients may be used:

$${w}_{1} = {e}^{- j ( ∠ {h}_{1} + {φ}_{1} )} \qquad ( eq . 4 a )$$

$${w}_{2} = {e}^{- j ( ∠ {h}_{2} + {φ}_{2} + 2 π ( {f}_{2} - {f}_{1} ) t - 2 π {f}_{2} τ )} \qquad ( eq . 4 b )$$

where ∠(x) denotes the angle of a complex variable x. The resulting composite signal, when the above co-phasing coefficients in eq. 4a-4b are applied, is then:

$${y}^{*} ( t ) = ( \vert {h}_{1} \vert + \vert {h}_{2} \vert ) s ( t ) {e}^{j 2 π {f}_{1} t} \qquad ( eq . 5 )$$

Alternatively, the co-phasing coefficients may be as follows:

$${w}_{1} = 1 \qquad ( eq . 6 a )$$

$${W}_{2} = {e}^{- j ( ∠ {h}_{2} + {φ}_{2} - ∠ {h}_{1} + {φ}_{1} + 2 π ( {f}_{2} - {f}_{1} ) t - 2 π {f}_{2} τ )} \qquad ( eq . 6 b )$$

The resulting composite signal, when the above co-phasing coefficients in eq. 6a-6b are applied, is then

$${y}^{*} ( t ) = ( \vert {h}_{1} \vert + \vert {h}_{2} \vert ) s ( t ) {e}^{j ( 2 π {f}_{1} t + {φ}_{1} )} \qquad ( eq . 7 )$$

Note that the only difference between eq.5 and eq.7 is a phase factor e^{jφ}^{₁}. The phase factor e^{j(2π}^{₁}^{t+φ}^{₁}⁾ will be removed at the WD receiver and has no impact on receiver performance.

Note that the above applies also in case of multiple antenna ports are deployed in each of the TRPs. In that case, additional precoding or beamforming may be applied to s(t), where s(t) is data associated with a MIMO layer of PDSCH or DMRS. The signal received from TRP1 would become H₁V₁w₁s(t)e^{j(2πf}^{₁}^{t+φ}^{₁}⁾, where H₁ is a N₁ by M channel matrix, V₁ is a N₁ by 1 precoding vector associated with the corresponding MIMO layer, N₁ is the number of antenna ports deployed at TRPs and M is the number of receive antennas at the WD 22. Similarly, the signal received from TRP2 would become H₂V₂w₂s(t−τ)e^{j(2πf}^{₂}^{(t-τ)+φ}^{₂}⁾, where H₂ is a N₂ by M channel matrix, V₂ is a N₂ by 1 precoding vector associated with the corresponding MIMO layer, N₂ is the number of antenna ports deployed at TRP2. For CJT, it is envisioned that {V₁, V₂} and the co-phasing coefficients {w₁, w₂} are reported by the WD 22 as part of precoding matrix indicator (PMI) in CSI.

### Delay and Frequency Pre-Compensation

It may be observed from eq. 4b and eq. 6b that in presence of propagation delay difference between the two TRPs, the desired co-phasing coefficients are frequency dependent, i.e., different set of co-phasing coefficients are needed at different frequencies. In presence of a frequency difference between the two TRPs, the co-phasing coefficients are also time dependent, i.e., different set of co-phasing coefficients are needed at different time instances. Therefore, if both propagation delay and frequency are different from the two TRPs, the desired co-phasing coefficients are both frequency and time dependent.

It is envisioned that for CSI feedback in CJT over two TRPs, a CSI-RS resource set containing two CSI-RS resources, one from each TRP, may be configured and sent to the WD 22 as illustrated in FIG. 19. The WD 22 may be configured to measure and report CSI based on the two CSI-RS resources to the network node 16 either via one of the TRPs or both TRPs. The CSI may contain one or more of a precoding matrix indicator (PMI), a rank indicator (RI), one or more channel quality indicators (CQIs), and a CSI-RS resource indicator (CRI). The CSI may be reported per CSI subband. The co-phasing coefficients w₁ and w₂ may be measured and reported as part of the PMI or as separate parameters.

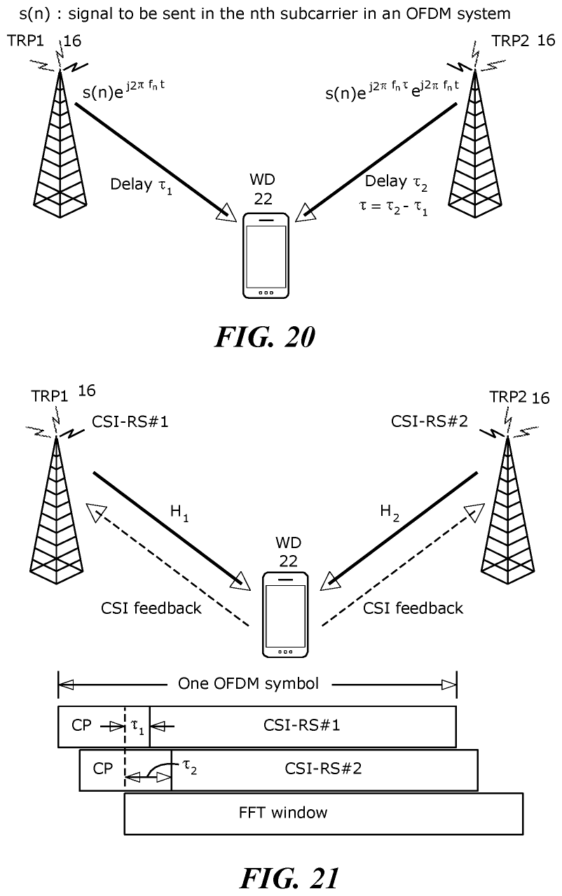

To keep the existing CSI subband size for CSI feedback, in some embodiments, the delay difference between TRPs is pre-compensated such that the signals from the two TRPs reach the WD 22 at the same time. This may be achieved by applying a time advance of t to s(t) at TRP2 or applying a time delay τ to s(t) at TRP1, or applying a time advance of τ/2 to s(t) at TRP2 and a time delay of τ/2 to s(t) at TRP1. In an OFDM system, the delay pre-compensation may be accomplished by applying a phase rotation to the signal to be sent in each subcarrier. An example is shown in FIG. 20, where a signal s (n) to be sent on the n^{th} subcarrier is multiplied by e^{j2πf}^{ₙ}^{τ} before sent from TRP2 and fₙ is the transmit frequency of the n^{th} subcarrier.

With delay pre-compensation, the frequency dependent phase item in the desired co-phasing coefficients w₁ and w₂ may be eliminated and the existing CSI/PMI subband sizes may be used for CSI feedback.

The delay difference (e.g., τ=τ₂−τ₁) between TRPs may be reported by the WD 22 based on a DL signal such as TRS, CSI-RS, or DMRS. The WD 22 may alternatively report a delay difference for each TRP with respect to a common time reference at the WD 22, e.g., τ₁ and τ₂. For instance, consider two CSI-RSs in a slot corresponding to the two TRPs where CSI-RS #1 starts at the 4^{th} symbol within the slot and CSI-RS #2 starts at the 8^{th} symbol within the slot. The actual arrival time of CSI-RS #1 or CSI-RS #2 may be earlier or later than the expected symbol start time by the WD 22. Then, the expected starting time of the respective CSI-RSs within the slot is used as the common time reference when computing the delay difference for the respective TRPs. In another embodiment, the network node 16 may measure the time difference between the TRPs based on a UL signal (such as SRS, DMRS) transmitted by the WD 22. See FIG. 21.

In another embodiment, to enable CJT with practical w₁ and w₂ feedback latency in the presence of transmit frequency differences between TRPs, frequency pre-compensation may be applied at the TRPs such that the transmit frequencies from all TRPs are the same at the WD 22. This may be achieved by applying a frequency correction at each of the TRPs except a reference TRP (e.g., TRP #1 in the above examples) so that the frequencies from all TRPs are aligned with the frequency of the reference TRP. With frequency pre-compensation, the time dependent component in the co-phasing coefficients w₁ and w₂ may be eliminated, and the co-phasing coefficients measured at one time may be applied in a later time if the channel remains unchanged during the time period.

Frequency differences between TRPs may be measured and reported by a WD 22 based TRP specific reference signals such as TRS. Alternatively, frequency differences between TRPs may be measured by network node-based UL signals such as a sounding reference signal (SRS) or DMRS received at the TRPs.

In some embodiments, the delay and/or frequency pre-compensation may be applied to both the CSI-RS and PDSCH, including the associated DMRS. Since the delay difference may be different for different WDs and also, different WDs may experience different Doppler shifts, delay and frequency pre-compensation for CSI-RS is good for WD 22 dedicated CSI-RS such as aperiodic CSI-RS.

In some embodiments, the delay and frequency pre-compensation are applied to PDSCH and the associated DMRS, while only frequency pre-compensated is applied to CSI-RS. In this case, the delay related components may be removed at the WD 22 before computing CSI. An example is shown in FIG. 20, where the channels associated with CSI-RS #1 and CSI-RS #2 are H₁e^{-j2πfτ}^{₁} and H₂e^{-j2πfτ}^{₂} respectively. CSI computation may be based H₁ and H₂ only, and e^{-j2πfτ}^{₁} and e^{-j2πfτ}^{₂} are not used because they will be pre-compensated for PDSCH and DMRS. When the WD 22 removes the delay related components τ₁ and τ₂, these components or equivalent parameters may be reported by the WD 22 together with the CSI for delay pre-compensation of PDSCH and DMRS. A benefit of this embodiment is that the delay or delay difference between TRPs may be reported together with CSI and no separate measurement and feedback for delay/delay difference is needed.

### QCL Signaling in Case of Pre-Compensation

Whether delay and/or frequency pre-compensation are applied to CSI-RS, PDSCH and DMRS should be signaled to the WD 22 so that proper actions may be taken. For example, if PDSCH and associated DMRS are delay pre-compensated while the associated QCL source RS is not, then the WD 22 cannot derive averaged delay for the DMRS based on the QCL source RS. Similarly, if the PDSCH and associated DMRS are frequency pre-compensated while the associated QCL source RS is not, then the WD 22 cannot derive frequency shift for the DMRS based on the QCL source RS.

To signal that delay and frequency pre-compensation have been performed by the network, in some embodiments, new QCL types may be introduced such that average delay and/or frequency offset are not included in the new QCL types. For example, a QCL-TypeX for {Doppler spread, delay spread} may be introduced to indicate QCL relation between a delay and frequency pre-compensated PDSCH and a TRS as the QCL source RS. In another example, QCL-TypeY for {average delay, delay spread, Doppler spread} may be introduced to indicate QCL relation between a frequency pre-compensated CSI-RS and a TRS as the QCL source RS. In this case, a TCI state with one of new QCL types may be indicated to a PDSCH or CSI-RS resource when pre-compensation has been applied to the PDSCH or CSI-RS.
‘QCL-TypeX’: {Doppler spread, delay spread}; and/or
‘QCL-TypeY’: {Doppler spread, delay spread, average delay}.

In some embodiments, delay and/or frequency pre-compensation may be implicitly indicated. For example, one of the multiple TRPs may be used as a reference TRP and delay and frequency offsets of other TRPs with respect to the reference TRP are measurement and pre-compensated. In this case, the reference TRP is not pre-compensated. In some embodiments, the reference TRP is always associated with the first TCI state activated for a TCI codepoint in DCI. When a TCI codepoint is indicated to a WD 22 in DCI scheduling a PDSCH, in some embodiments, the WD 22 may assume that part of the PDSCH transmitted from the TRP associated with the first TCI state indicated in the TCI codepoint is not pre-compensated while a remaining part of the same PDSCH transmitted from the rest of the TRPs are pre-compensated.

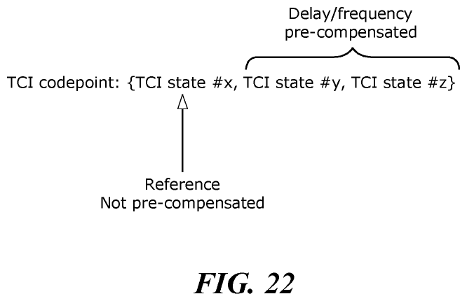

An example is shown in FIG. 22, where the first TCI state, TCI state #x, is the reference TCI state and the associated PDSCH/DMRS is not pre-compensated while PDSCH/DMRS associated with the other two TCI states #y and #z are pre-compensated. The WD 22 may derive average delay and Doppler shift based on only the RS specified in TCI state #x.

In some embodiments, the reference TRP is associated with the TCI state with the lower TCI state ID among the TCI states activated for a TCI codepoint in DCI. When a TCI codepoint is indicated to a WD 22 in DCI scheduling a PDSCH, in some embodiments, the WD 22 assumes that part of the PDSCH transmitted from the TRP associated with the TCI state with the lower TCI state ID among the TCI states indicated in the TCI codepoint is not pre-compensated while a remaining part of the same PDSCH transmitted from the rest of the TRPs are pre-compensated.

In some embodiments, the reference TRP is associated with the TCI state with the higher TCI state ID among the TCI states activated for a TCI codepoint, in some embodiments, the WD 22 assumes that part of the PDSCH transmitted from the TRP associated with the TCI state with the higher TCI state ID among the TCI states indicated in the TCI codepoint is not pre-compensated while a remaining part of the same PDSCH transmitted from the rest of the TRPs are pre-compensated.

In case of multiple aperiodic CSI-RS resources in a CSI-RS resource set configured for CJT CSI measurement and report, in some embodiments, the first CSI-RS resource is the reference CSI-RS resource and is not pre-compensated while a remaining CSI-RS resources in the resource set are pre-compensated and thus only {Doppler spread, delay spread} properties are derived from the corresponding QCL source RS. Whether pre-compensation is applied to CSI-RS may be explicitly configured either in the associated aperiodic CSI trigger state or implicitly indicated when a CJT CSI is triggered.

In some scenarios, the TRPs involved in CJT for a WD 22 may be different at different times due to WD 22 movement and/or channel changes. Generally, the TCI states associated with the TRPs over which a PDSCH is transmitted may be indicated to the WD 22 for determining channel filter parameters. With 4 TRPs, for example, in a scheduling cluster for which CSI is measured and fed back, 15 TCI codepoints may be needed to signal different combination of TRPs for CJT PDSCH transmissions including transmissions from a single TRP. For implicit signaling and to support all the possible combinations, 32 TCI codepoints may be needed.

With delay and frequency pre-compensation, the average delay and frequency from different TRPs are almost the same. In addition, the differences in delay and Doppler spread among TRPs are also small in a homogeneous network with uniformly distributed TRPs. Therefore, in some embodiments, a TCI codepoint may contain only the TCI state associated with the reference TRP. Thus, from the perspective of the WD receiver, CJT based PDSCH from multiple TRPs is the same as PDSCH transmission from a single TRP.

In some embodiments, for CJT based PDSCH, a TCI codepoint containing TCI states associated with all TRPs configured for CJT regardless of the actual TRPs over which a PDSCH is transmitted. For example, when 4 TRPs are in a cluster for potential CJT, the following TCI codepoints may be activated for implicit signaling:
TCI states {a,b,c,d};
TCI states {b,c,d,a};
TCI states {c,d,a,b}; and/or
TCI states {d,a,b,c}.
   where TCI states a, b, c, and d are associated with the 1^{st} to 4^{th} TRPs, respectively.

For CSI-RS, when delay and frequency pre-compensation are applied, one of the CSI-RS resources in a CSI-RS resource set may be a reference CSI-RS resource and be not pre-compensated. The other CSI-RS resources may be pre-compensated such that their delays and transmit frequencies are aligned with the reference CSI-RS resource. The reference CSI-RS resource may be configured with a QCL typeA source RS while other CSI-RS resources are configured with a QCL typeX (i.e. {Doppler spread, delay spread}) RS. In addition, the QCL RS for the reference CSI-RS resource may be configured as QCL type C (i.e., {Doppler shift, average delay}) RS for the other CSI-RS resources.

Alternatively, the reference CSI-RS resource may be implicitly indicated. For example, the first CSI-RS resource in the SRS resource set may be the reference CSI-RS resource when CJT based CSI feedback is configured.

Although the discussion above focused on PDSCH or CSI-RS, the same ideas may be applied to other DL signals.

In addition, a TRP may be associated with a CSI-RS resource in a CSI-RS resource set, a TCI state, a DL reference signal such as TRS, etc.

Some embodiments may include one or more of the following.

A method in a WD 22 for coherent joint transmission of a PDSCH from multiple TRPs to a WD 22 is disclosed. The method may include one or more of the following:
Pre-compensating delay and/or frequency differences among the TRPs for the PDSCH before applying a set of co-phasing coefficients to the PDSCH across the TRPs;
The delay and/or frequency differences are either measured and reported by a WD 22 based on a DL reference signal or measured by network node 16 based at the TRPs based on a UL signal:
   A reference TRP (or reference signal) among the multiple TRPs (or reference signals) may be indicated either explicitly or implicitly to a WD 22 and the delay and/or frequency differences are with respect to the reference TRP (or the reference signal);
The co-phasing coefficients are measured and reported by the WD 22 based multiple CSI-RS resources, one per TRP:
   The co-phasing coefficients may be part of CSI feedback;
   The pre-compensated may also be applied to the CSI-RS resources; and/or
The TRPs or the associated DL reference signals over which a PDSCH or CSI-RS resources are pre-compensated are indicated to the WD 22 either explicitly by introducing one or more new QCL types or implicitly so that WD 22 does not derive certain channel properties based on the QCL source RS for the PDSCH or CSI-RS reception.

A method in a network node 16 of coherent joint transmission of a DL signal from multiple TRPs to a WD 22, may include one or more of the following:
Obtaining delay and/or frequency differences between each of the multiple TRPs and a reference TRP, which is one of the multiple TRPs;
Obtaining a CSI feedback from the WD 22, wherein the CSI including a PMI per subband indicating an joint antenna precoder across the multiple TRPs and the precoder including a set of co-phasing coefficients one per TRP;
Applying a delay and/or a frequency pre-compensation to the DL signal before applying antenna precoding at each subband to the signal:
   Wherein the delay pre-compensation is to apply a time delay or time advance (or the equivalently a phase shift at each subcarrier in the frequency domain) at each of the multiple TRPs based on the obtained delay differences such that the DL signal from the TRPs arriving at the WD 22 at the same time;
   Wherein the frequency pre-compensation is to apply a frequency correction at each of the multiple TRPs based on the obtained frequency differences such that the DL signal from the TRPs arriving at the WD 22 at the same frequency;
Applying antenna precoding to the pre-compensated DL signal at the multiple TRPs at each subband;
Explicitly signaling of QCL information for the pre-compensated DL signal with one or more new QCL types without containing average delay and/or Doppler/frequency shift;
Implicitly signaling of QCL information for pre-compensated DL signal:
   Linking a reference TRP without pre-compensation to a first TCI state activated in each TCI codepoint;
   The rest of the TCI states are associated with TRPs over which the PDSCH is pre-compensated (UE).

A method of receiving a DL signal from multiple TRPs, may include one or more of the following:
Receiving a configuration of CSI feedback for coherent joint transmission, wherein the configuration including multiple CSI-RS resources, one for each TRP, and wherein a common QCL source reference signal is indicated for Doppler shift and average time delay for all the CSI-RS resources;
Receiving a request for CSI feedback based on the configuration;
Compute CSI according to the configuration, wherein the CSI including a PMI for each subband indicating an joint antenna precoder across the multiple TRPs including a set of co-phasing coefficients among the TRPs;
Receiving a DCI format scheduling a PDSCH, wherein the DCI format indicates multiple TCI states; and/or
Receive the PDSCH according to the TCI states, wherein only one of the TCI states is used to derived “Doppler shift” and “average delay” for the PDSCH reception.

Some embodiments may include one or more of the following:

Embodiment A1. A network node configured to communicate with a wireless device, WD, the network node configured to, and/or comprising a radio interface and/or comprising processing circuitry configured to:
receive from the WD a precoder matrix indicator, PMI, per subband indicating a joint antenna precoder for the plurality of transmission reception points, TRPs;
apply one of a delay and a frequency pre-compensation to a downlink signal; and
apply an antenna precoding at each subband to the pre-compensated downlink signal based on the indicated joint antenna precoder.

Embodiment A2. The network node of Embodiment A1, wherein the one of the delay and frequency pre-compensation is based at least in part on a time delay between TRPs.

Embodiment A3. The network node of any of Embodiments A1 and A2, wherein applying one of a delay and a frequency pre-compensation includes applying the one of the delay and the frequency pre-compensation to the plurality of TRPs.

Embodiment A4. The network node of any of Embodiments A1-A3, Embodiment A4, wherein the network node, radio interface and/or processing circuitry are further configured to transmit quasi-co-location, QCL, information to the WD.

Embodiment A5. The network node of any of Embodiments A1-A4, wherein the network node, radio interface and/or processing circuitry are further configured to link a first TRP to a first transmission configuration indicator, TCI, state and to associate a set of remaining TCI states with other TRPs.

Embodiment B1. A method implemented in a network node configured to communicate with a wireless device, WD, the method comprising:
receiving from the WD a precoder matrix indicator, PMI, per subband indicating a joint antenna precoder for the plurality of transmission reception points, TRPs;
applying one of a delay and a frequency pre-compensation to a downlink signal; and
applying an antenna precoding at each subband to the pre-compensated downlink signal based on the indicated joint antenna precoder.

Embodiment B2. The method of Embodiment B1, wherein the one of the delay and frequency pre-compensation is based at least in part on a time delay between TRPs.

Embodiment B3. The method of any of Embodiments B1 and B2, wherein applying one of a delay and a frequency pre-compensation includes applying the one of the delay and the frequency pre-compensation to the plurality of TRPs.

Embodiment B4. The method of any of Embodiments B1-B3, further comprising transmitting quasi-co-location, QCL, information to the WD.

Embodiment B5. The method of any of Embodiments B1-B4, further comprising linking a first TRP to a first transmission configuration indicator, TCI, state and associating a set of remaining TCI states with other TRPs.

Embodiment C1. A wireless device (WD) configured to communicate with a network node, the WD configured to, and/or comprising a radio interface and/or processing circuitry configured:
pre-compensate one of a delay difference and frequency difference among multiple transmission reception points, TRPs, for a physical downlink shared channel, PDSCH; and
apply a set of co-phasing coefficients to the PDSCH for the TRPs.

Embodiment C2. The WD of Embodiment C1, wherein the one of the delay difference and frequency difference is determined based at least in part on measurements at the WD.

Embodiment C3. The WD of Embodiment C1, wherein the one of the delay difference and frequency difference is determined based at least in part on measurements at the network node.

Embodiment C4. The WD of any of Embodiments C1-C3, wherein the one of the delay difference and frequency difference is based at least in part on a reference signal associated with a reference TRP.

Embodiment C5. The WD of any of Embodiments C1-C4, wherein the WD, radio interface and/or processing circuitry are further configured to determine a set of channel properties based at least in part on a quasi-co-location type.

Embodiment C6. The WD of any of Embodiments C1-C5, wherein the WD, radio interface and/or processing circuitry are further configured to transmit the co-phasing coefficients to the network node.

Embodiment D1. A method implemented in a wireless device (WD) configured to communicate with a network node, the method comprising:
pre-compensating one of a delay difference and frequency difference among multiple transmission reception points, TRPs, for a physical downlink shared channel, PDSCH; and
applying a set of co-phasing coefficients to the PDSCH for the TRPs.

Embodiment D2. The method of Embodiment D1, wherein the one of the delay difference and frequency difference is determined based at least in part on measurements at the WD.

Embodiment D3. The method of Embodiment D1, wherein the one of the delay difference and frequency difference is determined based at least in part on measurements at the network node.

Embodiment D4. The method of any of Embodiments D1-D3, wherein the one of the delay difference and frequency difference is based at least in part on a reference signal associated with a reference TRP.

Embodiment D5. The method of any of Embodiments D1-D4, further comprising determining a set of channel properties based at least in part on a quasi-co-location type.

Embodiment D6. The method of any of Embodiments D1-D5, further comprising transmitting the co-phasing coefficients to the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a wireless device, WD (22), the network node (16) configured for coherent joint transmission, CJT, of a downlink, DL, channel to the WD (22) over a first transmission and reception point, TRP, and a second TRP in a same time and frequency resource, the network node (16) comprising:
a radio interface (62) configured to:
transmit to the WD (22), a first reference signal, RS, over the first TRP and a second RS over the second TRP;
receive from the WD (22), information relating to at least one of a time delay difference and a frequency difference between the first and the second TRPs at the WD (22), wherein the second TRP is a reference TRP;
transmit to the WD (22), the DL channel with at least one of a delay pre-compensation and a frequency pre-compensation over the first TRP and without delay and frequency pre-compensation over the second TRP; and
transmit to the WD (22), quasi co-location, QCL, information indicating whether the DL channel transmitted from each of the first and second TRPs is pre-compensated; and
a processing circuitry (68) in communication with the radio interface (62) and configured to pre-compensate the downlink channel transmitted to the WD (22) over the first TRP according to the received at least one of the time delay difference and frequency difference.

2. The network node (16) of claim 1, wherein the DL channel is a Physical Downlink Shared Channel, PDSCH.

3. The network node (16) of any of claims 1 and 2, wherein the QCL information is included in a DL control information, DCI, format scheduling the DL channel.

4. The network node (16) of claim 3, wherein the QCL information for the DL channel transmitted from the first TRP is included in a first transmission configuration indication, TCI, state and the QCL information for the DL channel transmitted from the second TRP is included in a second transmission configuration indication, TCI, state, the first and second TCI states being indicated in a TCI codepoint of a TCI field in downlink control information, DCI.

5. The network node (16) of claim 4, wherein the QCL information in the first TCI state includes both an average delay and Doppler shift properties, while the QCL information in the second TCI state does not include either of the average delay and the Doppler shift properties.

6. The network node (16) of any of claims 4 and 5, wherein the first and the second TCI states are indicated one of implicitly and explicitly.

7. The network node (16) of any of claims 4 and 5, wherein only the first TCI state is indicated in the TCI codepoint in the DCI.

8. The network node (16) of any of claims 1-7, wherein the delay pre-compensation is performed by applying one of a time advance and a time delay to the DL channel.

9. The network node (16) of any of claims 1-8, wherein the frequency pre-compensation is performed by applying a frequency correction to the DL channel.

10. The network node (16) of any of claims 1-9, wherein the QCL information further indicates one of delay pre-compensation, frequency pre-compensation, both delay and frequency pre-compensation, and no pre-compensation.

11. The network node (16) of any of claims 1-10, wherein the at least one of the delay pre-compensation and the frequency pre-compensation is performed by applying a phase rotation in each subcarrier of the DL channel or signal

12. The network node (16) of any of claims 1-11, wherein the radio interface (62) is further configured to receive channel state information, CSI, feedback from the WD (22), the CSI feedback including a precoding matrix indicator, PMI, indicating a first precoding matrix for the DL channel from the first TRP and indicating a second precoding matrix for the DL channel from the second TRP.

13. The network node (16) of any of claims 1-12, wherein the first RS and the second RS are channel state information reference signals, CSI-RS.

14. The network node (16) of any of claims 1-12, wherein the first RS and the second RS are tracking reference signals, TRS.

15. The network node (16) of any of claims 1-14, wherein the time delay difference and the frequency difference are reported with channel state information, CSI.

16. The network node (16) of any of claims 1-15, wherein at least one of the time delay difference and the frequency difference are obtained by the network node (16) based at least in part on uplink measurements on uplink reference signals.

17. A method in a network node (16) configured to communicate with a wireless device, WD (22), the network node (16) configured for coherent joint transmission, CJT, of a downlink, DL, channel to the WD (22) over a first transmission and reception point, TRP, and a second TRP in a same time and frequency resource, the method comprising:
transmitting (S144) to the WD (22), a first reference signal, RS, over the first TRP and a second RS over the second TRP;
receiving (S146) from the WD (22), information relating to at least one of a time delay difference and a frequency difference between the first and the second TRPs at the WD (22), wherein the second TRP is a reference TRP;
transmitting (S148) to the WD (22), the DL channel with at least one of a delay pre-compensation and a frequency pre-compensation over the first TRP and without delay and frequency pre-compensation over the second TRP;
transmitting (S150) to the WD (22), quasi co-location, QCL, information indicating whether the DL channel transmitted from each of the first and second TRPs is pre-compensated; and
pre-compensating (S152) the downlink channel transmitted to the WD (22) over the first TRP according to the received at least one of the time delay difference and frequency difference.

18. The method of claim 17, wherein the DL channel is a Physical Downlink Shared Channel, PDSCH.

19. The method of any of claims 17 and 18, wherein the QCL information is included in a DL control information, DCI, format scheduling the DL channel.

20. The method of claim 19, wherein the QCL information for the DL channel transmitted from the first TRP is included in a first transmission configuration indication, TCI, state and the QCL information for the DL channel transmitted from the second TRP is included in a second transmission configuration indication, TCI, state, the first and second TCI states being indicated in a TCI codepoint of a TCI field in downlink control information, DCI.

21. The method of claim 20, wherein the QCL information in the first TCI state includes both an average delay and Doppler shift properties, while the QCL information in the second TCI state does not include either of the average delay and the Doppler shift properties.

22. The method of any of claims 20 and 21, wherein the first and the second TCI states are indicated one of implicitly and explicitly.

23. The method of any of claims 20 and 21, wherein only the first TCI state is indicated in the TCI codepoint in the DCI.

24. The method of any of claims 17-23, wherein the delay pre-compensation is performed by applying one of a time advance and a time delay to the DL channel.

25. The method of any of claims 17-24, wherein the frequency pre-compensation is performed by applying a frequency correction to the DL channel.

26. The method of any of claims 17-25, wherein the QCL information further indicates one of delay pre-compensation, frequency pre-compensation, both delay and frequency pre-compensation, and no pre-compensation.

27. The method of any of claims 17-26, wherein the at least one of the delay pre-compensation and the frequency pre-compensation is performed by applying a phase rotation in each subcarrier of the DL channel or signal

28. The method of any of claims 17-27, further comprising receiving channel state information, CSI, feedback from the WD (22), the CSI feedback including a precoding matrix indicator, PMI, indicating a first precoding matrix for the DL channel from the first TRP and indicating a second precoding matrix for the DL channel from the second TRP.

29. The method of any of claims 17-28, wherein the first RS and the second RS are channel state information reference signals, CSI-RS.

30. The method of any of claims 17-28, wherein the first RS and the second RS are tracking reference signals, TRS.

31. The method of any of claims 17-30, wherein the time delay difference and the frequency difference are reported with channel state information, CSI.

32. The method of any of claims 17-31, wherein at least one of the time delay difference and the frequency difference are obtained by the network node (16) based at least in part on uplink measurements on uplink reference signals.

33. A wireless device, WD (22), configured to communicate with a plurality of transmission reception points, TRPs, at a network node, the WD (22) comprising:
a radio interface (82) configured to receive from the network node (16) a configuration to report at least one of a delay difference and a frequency difference between the first and the second TRPs based at least in part on a first reference signal, RS, and a second RS, the first RS and the second RS being transmitted from the first TRP and the second TRP, respectively; and
processing circuitry (84) in communication with the radio interface (82) and configured to estimate at least one of the delay difference and the frequency difference based at least in part on the first and the second RS;
the radio interface (82) being further configured to:
report to the network node (16) the estimated at least one of the delay difference and the frequency difference;
receive from the network node (16) a downlink channel scheduled by a downlink control information, DCI, format and quasi co-location, QCL, information about the downlink channel in the DCI, the downlink channel being transmitted over both the first and the second TRPs; and
decode the downlink channel according to the QCL information.

34. The WD (22) of claim 33, wherein the delay difference includes at least one of a timing difference and a propagation delay difference between the first and the second TRPs.

35. The WD (22) of claim 33, wherein the frequency difference includes at least one of a downlink carrier frequency difference and a downlink Doppler frequency difference between the first and the second TRPs.

36. The WD (22) of any of claims 33-35, wherein the downlink channel is a physical downlink shared channel, PDSCH.

37. The WD (22) of any of claim 33-36, wherein the QCL information for the DL channel transmitted from the first is included in a first transmission configuration indication, TCI, state and the QCL information for the downlink channel transmitted from the second TRP is included in a second TCI, state, at least one of the first and second TCI states being indicated in a TCI codepoint of a TCI field in the DCI.

38. The WD (22) of claim 37, wherein the QCL information in the first TCI state includes Doppler shift, Doppler spread, average delay and delay spread.

39. The WD (22) of any of claims 37 and 38, wherein the QCL information in the second TCI state excludes at least one of Doppler shift and average delay.

40. The WD (22) of any of claims 37-39, wherein only the first TCI state is indicated in the TCI field of the DCI and QCL information included in the first TCI state is applied to a physical downlink shared channel, PDSCH.

41. The WD (22) of any of claims 33-40, wherein the QCL information further indicates a QCL source reference signal.

42. The WD (22) of any of claims 33-41, wherein decoding the DL channel according to the QCL information includes deriving channel properties indicated in the QCL information from an associated QCL source RS for the physical downlink shared channel, PDSCH, and using the channel properties to perform channel estimation for the PDSCH.

43. The WD (22) of any of claims 33-42, wherein each of the first and second RS is a channel state information reference signal, CSI-RS.

44. The WD (22) of any of claims 33-42, wherein each of the first and second RS is a tracking reference signal, TRS.

45. A method in a wireless device, WD (22), configured to communicate with a network node (16) comprising a first transmission reception point, TRP, and a second TRP, the method comprising:
receiving (S154) from the network node (16) a configuration to report at least one of a delay difference and a frequency difference between the first and the second TRPs based at least in part on a first reference signal, RS, and a second RS, the first RS and the second RS being transmitted from the first TRP and the second TRP, respectively;
estimating (S156) at least one of the delay difference and the frequency difference based at least in part on the first and the second RS;
reporting (S158) to the network node (16) the estimated at least one of the delay difference and the frequency difference;
receiving (S160) from the network node (16) a downlink channel scheduled by a downlink control information, DCI, format and quasi co-location, QCL, information about the downlink channel in the DCI, the downlink channel being transmitted over both the first and the second TRPs; and
decoding (S162) the downlink channel according to the QCL information.

46. The method of claim 45, wherein the delay difference includes at least one of a timing difference and a propagation delay difference between the first and the second TRPs.

47. The method of claim 45, wherein the frequency difference includes at least one of a downlink carrier frequency difference and a downlink Doppler frequency difference between the first and the second TRPs.

48. The method of any of claims 45-47, wherein the downlink channel is a physical downlink shared channel, PDSCH.

49. The method of any of claim 45-48, wherein the QCL information for the DL channel transmitted from the first is included in a first transmission configuration indication, TCI, state and the QCL information for the downlink channel transmitted from the second TRP is included in a second TCI, state, at least one of the first and second TCI states being indicated in a TCI codepoint of a TCI field in the DCI.

50. The method of claim 49, wherein the QCL information in the first TCI state includes Doppler shift, Doppler spread, average delay and delay spread.

51. The method of any of claims 49 and 50, wherein the QCL information in the second TCI state excludes at least one of Doppler shift and average delay.

52. The method of any of claims 49-51, wherein only the first TCI state is indicated in the TCI field of the DCI and QCL information included in the first TCI state is applied to a physical downlink shared channel, PDSCH.

53. The method of any of claims 33-52, wherein the QCL information further indicates a QCL source reference signal.

54. The method of any of claims 33-53, wherein decoding the DL channel according to the QCL information includes deriving channel properties indicated in the QCL information from an associated QCL source RS for the physical downlink shared channel, PDSCH, and using the channel properties to perform channel estimation for the PDSCH.

55. The method of any of claims 33-54, wherein each of the first and second RS is a channel state information reference signal, CSI-RS.

56. The method of any of claims 33-54, wherein each of the first and second RS is a tracking reference signal, TRS.
